(19) United States
(12) Patent Application Publication
(10) Pub. No.: US 2013/0283682 A1
(43) Pub. Date: Oct. 31, 2013

(54) SYSTEM FOR INTERACTING WITH ORGANIC MATERIAL

(71) Applicant: John Patoskie, Allen, TX (US)

(72) Inventor: John Patoskie, Allen, TX (US)

(21) Appl. No.: 13/455,484

(22) Filed: Apr. 25, 2012

(51) Int. Cl. A01G 17/06

(52) U.S. Cl. 47/45

(57) ABSTRACT

A system comprises a first section comprising a plurality of horizontal elements, wherein each of the elements consists of an integrated loop at either end of the elements, wherein the elements can be evenly spaced apart and a second section, comprising a plurality of horizontal elements, wherein each of the elements consists of an integrated loop at either end of the elements, wherein the elements can be evenly spaced apart.

### FIELD

This disclosure relates to the provision of content to gardening and in particular to systems for supporting, containing, protecting and composting organic material.

### BACKGROUND

There are many reasons people want to have a garden. For some, there is a concern regarding undesirable genetic modification, chemical usage in commercial food production, as well as other reasons. Some people find it difficult to afford the increased cost of items in a grocery store. Many people find the experience satisfying; the produce tastes better and/or they are supporting a green initiative.

People who attempt a garden often encounter obstacles that impact the success of their endeavor. The size of the plant may grow larger than the space allocated. Some systems of supporting the plant do not adjust to the life cycle of the plant. Some solutions are too specialized, require significant storage space, and cannot be used for other gardening considerations. Undesirable forces may want access to the plant or the fruits or vegetables that the plant produces.

Another obstacle to the successful production of fruits and vegetables is pollination. Most pollination occurs through insects and other animals. Many areas of the country are experiencing a reduction in these insects and have to create artificial substitutes or contend with reduced output. To aid pollination, people often use a soft object to transfer pollen from one flower to another.

When the plants stop producing or die, people need to decide what to do with the removed organic material. Besides throwing it away, some people compost. Most organic household material currently thrown away can also be composted. A common manner of composting is to put organic material in a pile or enclosure. While many solutions exist for this purpose, few can expand to different configurations, be used for alternative purposes or easily disassembled.

As such, what is required is an improved system for supporting, containing, protecting and composting organic material through its life cycle that has a minimal number of parts and that can be easily stored when not in use.

### SUMMARY

When growing plants, such as vegetables, herbs, flowers, vines, shrubs, trees or any member of the kingdom Plantae, several decisions need to be made such as determining the space allocated, the manner of protecting plants from herbivores, omnivores and the weather, the type of support needed for growing plants, the manner of aiding pollination as well as the means to compost the plants at the end of their life cycle. Each of these decisions typically requires one or more specialized solutions.

In one embodiment of the disclosure, a system of one or more sections can be joined and supported, for example with a rod. A rod, which acts as a combined hinge point, hinge-pin, support rod or stake, may be referenced for example as a hinge and rod, hinge-pin, hinge, support rod, stake and used interchangeably herein.

In one embodiment of the disclosure, a system includes sections that can be combined to establish a perimeter around one or more plants. This perimeter can be used as a barrier, for example to other plants, living creatures such as herbivores and omnivores, and air-borne intruders such as birds and insects. When combined with another material, protection can also be provided against excess wind, sun, cold and other elements.

In one embodiment of the disclosure, a system utilizing one or more sections can be joined to provide support for vines, branches, vegetables, or other growth of one or more plants as the plant develops.

In one embodiment of the disclosure, a system to aid in pollination is disclosed. Once supporting the plants, and if the plants are producing pollen, one or more of the sections can be moved through the act of shaking, bumping, or some other form of vibration, aiding in the release of pollen from one or more locations. Several geographical areas have noticed a decrease in pollinating insects and thus require artificial means to aid in fruit or vegetable production.

In one embodiment of the disclosure, a system of composting plants or other material is disclosed. At the end of a growing season, annual plants are usually removed. For many perennial plants, some form of pruning occurs. The material removed is often composted. One or more sections and rods of the disclosure used in supporting the plants can be employed to make an enclosure that can be applied towards composting or other activities.

In one embodiment of the disclosure, a system for storage of one or more sections and rods is disclosed. When a section is no longer needed, the section can be repositioned at the rod or disassembled by removing the rod. This significantly reduces the storage space required between uses.

In one embodiment of the disclosure, a system utilizing additional or specialized sections can be added to the one or more sections to address more specific requirements.

In one embodiment of the disclosure, a system, comprises a first section comprising a plurality of horizontal elements, wherein each of the elements consists of an integrated loop at either end of the elements, wherein the elements can be evenly spaced apart and a second section, comprising a plurality of horizontal elements, wherein each of the elements consists of an integrated loop at either end of the elements, wherein the elements can be evenly spaced apart.

In one embodiment of the disclosure, the system further comprises at least one vertical element coupled to the horizontal elements of the first section and at least one vertical element coupled to the horizontal elements of the second section, further comprising a rod configured to join the first section and the second section when positioned through the integrated loop at one end of each of the plurality of horizontal elements of the first section and through the integrated loop at one end of each of the plurality of horizontal elements of the second section, wherein the rod, while still configured to join the first section and the second section allows the sections to pivot at at least one angle, wherein the rod, while still configured to join the first section and the second section has sufficient length to be inserted into a substance, wherein the rod, while still configured to join the first section and the second section has sufficient length to integrate at least one further section, wherein the at least one further section is integrated vertically with at least one of: the first section, and the second section, wherein the rod is at least one of: a uniform length, a non-uniform length, a uniform thickness, a non-uniform thickness, extendable, includes a detachable end, is hooked at at least one end of the rod, is hollow at at least one end, is pointed on at least one end of the rod, is forked at at least one end of the rod, and is perforated at at least some portion of its length.

In one embodiment of the disclosure, the system comprises at least one horizontal element that consists of an integrated loop at either end of the at least one element, and at least one vertical element coupled to the at least one horizontal element.

In one embodiment of the disclosure, the system includes a space between the at least one horizontal element and a space between the at least one vertical element that is at least one of: a uniform distance, and a non-uniform distance, wherein the at least one horizontal element is configured to connect with one or more subsections that consists of at least one subsection horizontal element and at least one subsection vertical element, wherein the one or more subsections can be configured to move or be removed independent of the at least one horizontal element or the at least one vertical element, comprises an opening between the at least one horizontal element and the at least one vertical element, wherein the one or more subsections can be configured to move or be removed in proximity to the opening, wherein the at least one of the horizontal element and the at least one vertical element can be at least one of: straight, crooked, a uniform length, and a non-uniform length, wherein the integrated loop at either end of the at least one horizontal element is at least one of: a circle, a square, a triangle, an octagon, a uniform shape, a non-uniform shape, a uniform size, a non-uniform size, similar material, dissimilar material, solid, hollow, continuous, and non-continuous, wherein the integrated loop at either end of the at least one horizontal element is at least one of: fixed, detachably attached, and telescoping.

In one embodiment of the disclosure, the system further comprises at least one horizontal element that is at least one of: straight and crooked, wherein the at least one horizontal element consists of an integrated loop at either end of the at least one element, and at least one vertical element that is at least one of: straight and crooked, wherein the at least one vertical element is coupled to the at least one horizontal element.

In one embodiment of the disclosure, the system includes the elements that can be coupled to form at least one of: at least one section that extend in at least one direction, at least one section that forms at least one enclosure, at least one section that extends in at least one direction and that couples with at least one enclosure, at least one enclosure, an enclosure that couples with at least one similar enclosure, and an enclosure that couples with at least one dissimilar enclosure, wherein at least one of: at least one of the sections and at least one of the enclosures form at least one of: a roof, a floor, a shelf, and a wall, wherein at least one of the enclosures forms at least one of: a square, a rectangle, a triangle, a geometric shape with straight sides, a geometric shape with crooked sides, a simple polygon, a complex polygon, a regular polygon, a irregular polygon, and a geometric shape within another geometric shape, wherein at least one of: the at least one horizontal element, the at least one vertical element and a rod configured to join two or more of the systems, is configured to couple an object capable of facilitating movement.

### BRIEF DESCRIPTION OF THE DRAWINGS

Reference will now be made, by way of example only, to specific embodiments and to the accompanying drawings in which:

FIG. 1 depicts a section with loops incorporated into the horizontal elements according to an embodiment;

FIG. 2 depicts two sections with loops incorporated into the horizontal elements linked by a rod according to an embodiment;

FIG. 3a depicts three sections with loops incorporated into the horizontal elements all linked by a rod where each section is pointing in a different direction according to an embodiment;

FIG. 3b is a depiction of FIG. 3a, from a different focal point according to an embodiment;

FIG. 4 depicts sections linked by rods and creating an enclosure according to an embodiment;

FIG. 5 depicts sections of varying length linked by rods and creating an enclosure according to an embodiment;

FIG. 6 depicts a top view of a configuration where multiple sections share rods according to an embodiment;

FIG. 7 depicts a top view of an alternate configuration where multiple sections share rods according to an embodiment;

FIG. 8 depicts an enclosure within another enclosure according to an embodiment;

FIG. 9a depicts a front view and top view of single sections linked by rods to support climbing plants according to an embodiment;

FIG. 9b is a depiction of FIG. 9a, from a different focal point according to an embodiment;

FIG. 10 depicts a top view of single sections and combined sections sharing rods according to an embodiment;

FIG. 11a depict a mesh option attachment with loops incorporated into the horizontal elements according to an embodiment;

FIGS. 11b, 11c, and 11d depict several mesh option attachments with hooks incorporated at vertical points according to an embodiment;

FIG. 12 depicts a section combined with a mesh option attachment linked by a rod according to an embodiment;

FIGS. 13a, 13b, 13c and 13d depict several variations of a section with an independent hinged opening that still incorporates loops into the horizontal elements according to an embodiment;

FIGS. 14a, 14b, 14c and 14d depict a section which can be linked by a rod and used for expansion according to an embodiment;

FIG. 15 depicts a combination of sections applied to an uneven surface according to an embodiment;

FIG. 16 depicts a section with horizontal elements and vertical elements that are hollow according to an embodiment;

FIG. 17 depicts a section with a hollow vertical element allowing a rod to pass through according to an embodiment;

FIG. 18 depicts a section with interconnected horizontal elements and vertical elements that allow for the distribution of fluids according to an embodiment;

FIG. 19 depicts a section with horizontal elements and vertical elements of different lengths and with loops incorporated into the horizontal elements according to an embodiment;

FIG. 20 depicts a curved section with loops incorporated into the horizontal elements according to an embodiment;

FIG. 21 depicts a section with loops incorporated into the crooked horizontal elements according to an embodiment;

FIGS. 22a and 22b depict curved sections joined by a rod according to an embodiment;

FIG. 22c depicts an individual curved section creating a horizontal configuration according to an embodiment;

FIG. 23 depicts a combination of different types of sections according to an embodiment;

FIG. 24 depicts sections in addition to exterior structural support that form a roof, a floor, a shelf and a wall according to an embodiment;

FIG. 25 depicts a combination of various section options combined into a single section according to an embodiment;

FIG. 26 depicts a section with horizontal elements placed at different locations, with some horizontal elements incorporating loops while others do not according to an embodiment;

FIG. 27 depicts various options of loop forms according to an embodiment;

FIG. 28 depicts various options of a rod and rod end points according to an embodiment;

FIG. 29 depicts an enclosure formed with a section and an existing structure according to an embodiment;

FIG. 30 depicts a section with horizontal elements and vertical elements that have telescoping ends according to an embodiment;

FIG. 31 depicts a section with a telescoping vertical element inserted into a substance according to an embodiment;

FIG. 32 depicts a section with a telescoping vertical element inserted into another section with a hollow vertical element according to an embodiment;

FIG. 33 depicts another section with a telescoping vertical element inserted into a section with a hollow vertical element according to an embodiment;

FIG. 34 depicts a caster combined with a rod according to an embodiment;

FIG. 35 depicts a caster combined with a vertical element according to an embodiment;

FIG. 36 depicts a caster which can pivot combined with a horizontal element according to an embodiment;

FIG. 37 depicts sections combined internally and externally to allow for storage according to an embodiment;

FIG. 38 depicts sections combined to form an enclosure to restrict the movement of objects according to an embodiment;

FIG. 39 depicts a section with a solid material according to an embodiment; and

FIG. 40 depicts sections combined to form an enclosure with the solid material according to an embodiment.

### DETAILED DESCRIPTION

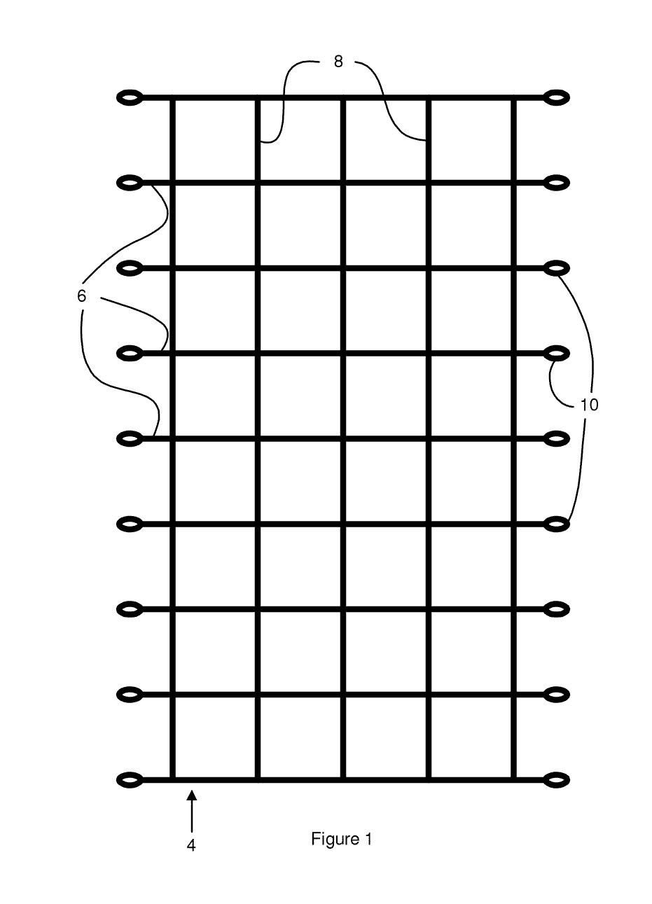

In FIG. 1, there is shown a section 4 on which some vertical and horizontal materials have been combined to make a section of a fixed height and width.

The ends of the horizontal elements 6 of the section 4 incorporate loops 10 at fixed points. These loops 10 are not independent of the section 4. Loops 10 may also be referred to as a connection point. A section 4 incorporates at least one vertical element 8 joined to at least one horizontal element 6. While section 4 has variations in function, in an embodiment, it is the same width to provide for interchangeability and integrated support at a designated location.

Each section 4 contains integrated loops 10 at defined locations to maximize support and rigidity. These loops 10 are formed as part of the section's cross support mechanism and are rigid in direction.

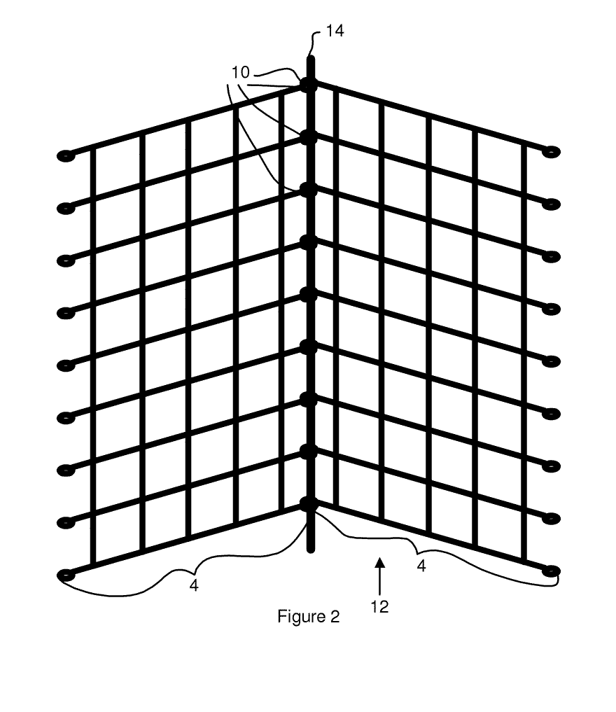

Referencing FIG. 2, a system 12 is created when a rod 14 is passed through the loops 10 on each adjoining section linking the two sections together. It should be noted throughout the document that any reference to a section 4 includes the loops 10, but not loops that are detachably attached (described later) as well as the rod 14. The more loops 10 interconnected from each section 4, the tighter the connection between sections 4 as well as increased rigidity when used for enclosures.

Storage of sections 4 and rods 14 requires minimal effort. In one embodiment, with the removal of the rod 14, individual sections 4 can be stacked requiring minimal storage. Not all rods 14 need to be removed to collapse a structure for storage. In another embodiment, with the rod 14 in place, sections 4 can be positioned on top of each other reducing the space needed to move or store the sections 4.

The sections 4 can be combined when a rod 14 is inserted through one or more of the loop 10 supports on adjoining sections 4.

The loops 10 when combined with a rod 14 allow for a hinge motion between adjoining sections 4 at fixed points.

Typically, rods 14 can be taller than the sections being joined. In one embodiment, the extended length of the rod 14 can be used for an additional purpose. Besides joining the sections 4 together, in one embodiment, the rod 14 can be pushed into a substance providing stability to the structure and plants. The substance could be dirt, mulch, or any matter configured to or able to receive the rod. In one embodiment, this can prevent the structure from falling over when the plants get larger, when the plants have a large quantity of fruits or vegetables and/or when strong winds are present. In another embodiment, the rod 14 can be easily loosened allowing motion to facilitate the release of pollen from the attached or nearby plants.

In one embodiment, the rods 14 can be shorter than the sections 4 being joined. As long as one or more loops 10 can be used in joining the sections 4, in one embodiment, the structure achieves a level of stability. In another embodiment, the rods 14 can be of various lengths and can be placed one on top of another to achieve different heights.

In one embodiment, a variation of the loops 10 is size or thickness. The smaller the size or the greater the thickness, the harder it is to pass a rod 14 between different loops 10. This increases rigidity. A larger size loop 10 in one embodiment allows multiple rods 14 that can be leveraged to connect sections 4, pushed into the ground as well as integrated to vertically extended sections.

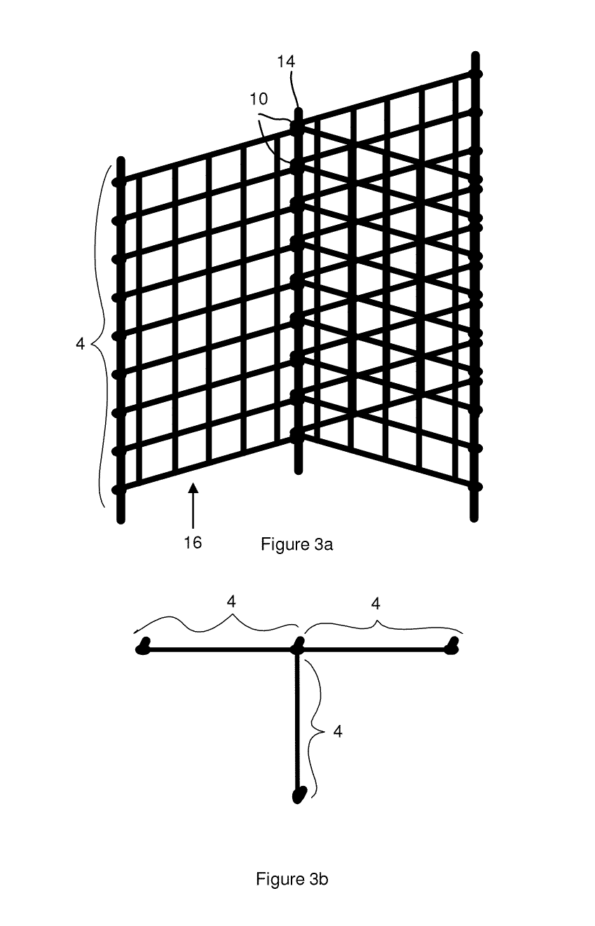

Referencing FIG. 3a, a system 16, in another embodiment, allows three sections 4 with incorporated loops 10 to be linked by a rod 14. This variation of the loop 10 connections allows for two or more sections 4 to be connected and the sections 4 pointing in multiple directions sharing a common rod 14. The term multiple directions refer to the same direction or to a different direction. Referencing FIG. 3b, a top view is shown of FIG. 3a.

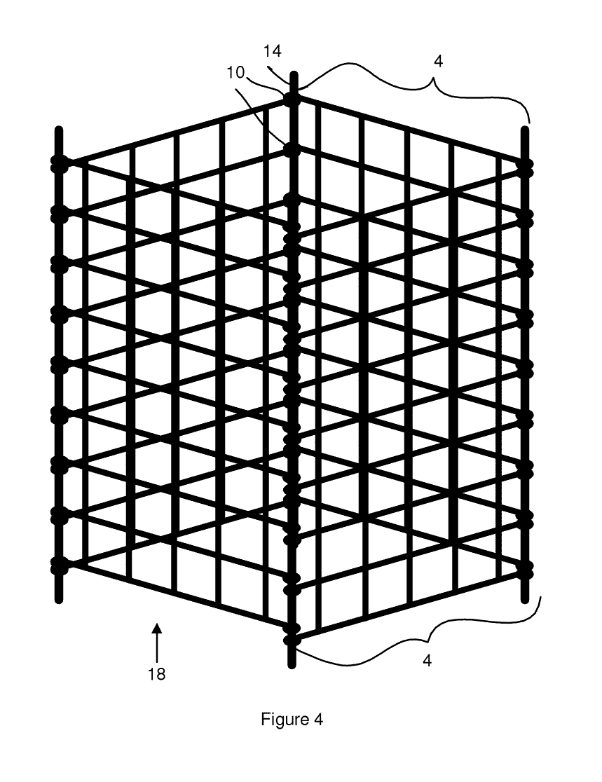

Referencing FIG. 4, a system 18, in another embodiment, allows independent enclosed areas to be created when a number of sections 4 can be joined and supported at the designated connection point 10 with rods 14 to form a polygon of any size and in at least one dimension/plane. In this embodiment, four sections 4 can be joined, but only three or more are required. Depending on the number of sections 4 used, any number of shapes such as triangles, squares, rectangles, pentagons, and all forms of polygon types can be created with ever increasing size of the enclosure. The types of polygons include, but are not limited to simple, complex, concave, convex, regular or irregular.

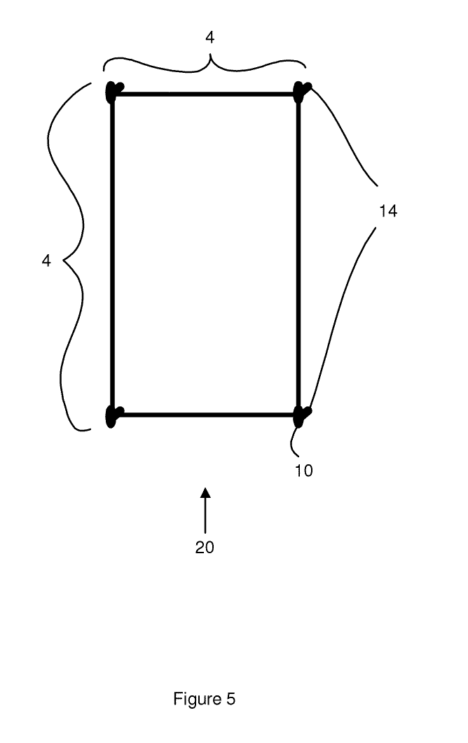

Referencing FIG. 5, a top view of a system 20, in another embodiment, has sections 4 of different widths. When joined in and supported at the designated connection point 10 with rods 14, polygons of the types mentioned above can be created.

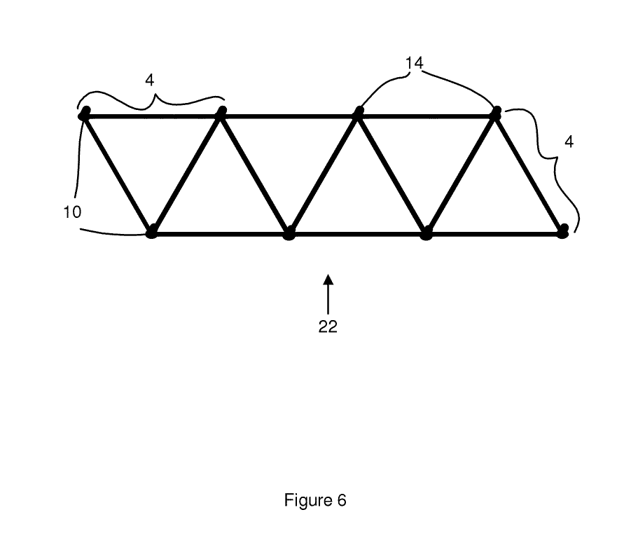

Referencing FIG. 6, a top view of a system 22, in another embodiment, enables similar enclosures to be joined to other similar enclosures by sharing a common side. In such a case, the common side is created using one section 4 minimizing the number of sections 4 required, while improving the rigidity of the structures and increasing the number of containment areas.

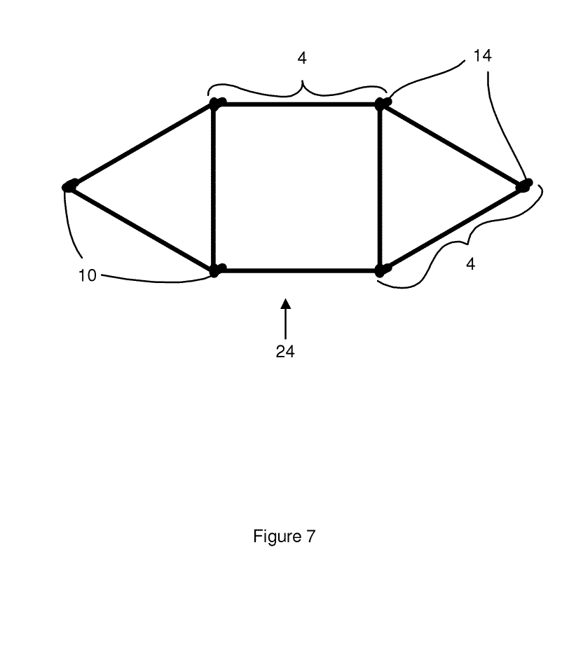

Referencing FIG. 7, a top view of a system 24, in another embodiment, allows similar and dissimilar enclosure configurations to be achieved through combining sections 4, loops 10 and rods 14 forming combinations of triangles, squares, rectangles, or polygons of the types mentioned above.

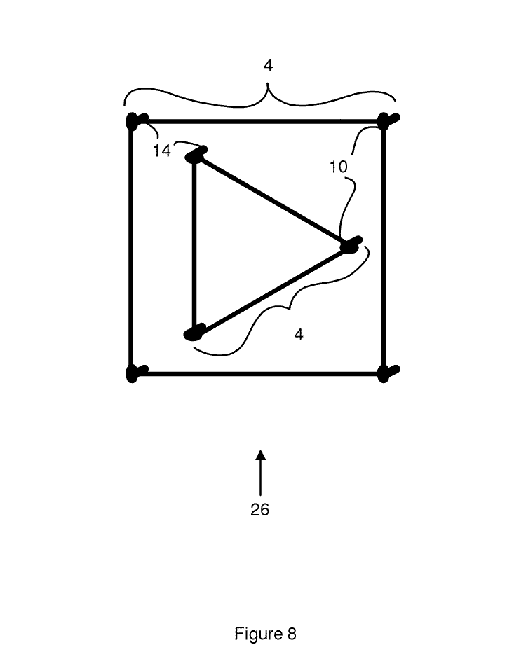

Referencing FIG. 8, a top view of a system 26, in another embodiment, depicts at least one independent enclosure made up of sections 4 of various lengths combined with a rod 14 within at least one enclosure made up of sections 4 of various lengths combined with a rod 14. In one embodiment one or more of the following can vary: the number of enclosures within enclosures, the width of sections 4, the height of sections 4 as well as the number of sections 4 used for each enclosure. This combination results in at least one combination of the polygon types mentioned above within at least one polygon type mentioned above. In another embodiment, these enclosures can be joined, for example at one or more loops 10 of aligned sections 4 with a rod 14. To gain access to an enclosure within an enclosure, at least one section 4 can be configured as a gate using the hinge function of a rod 14 through loops 10 in another embodiment.

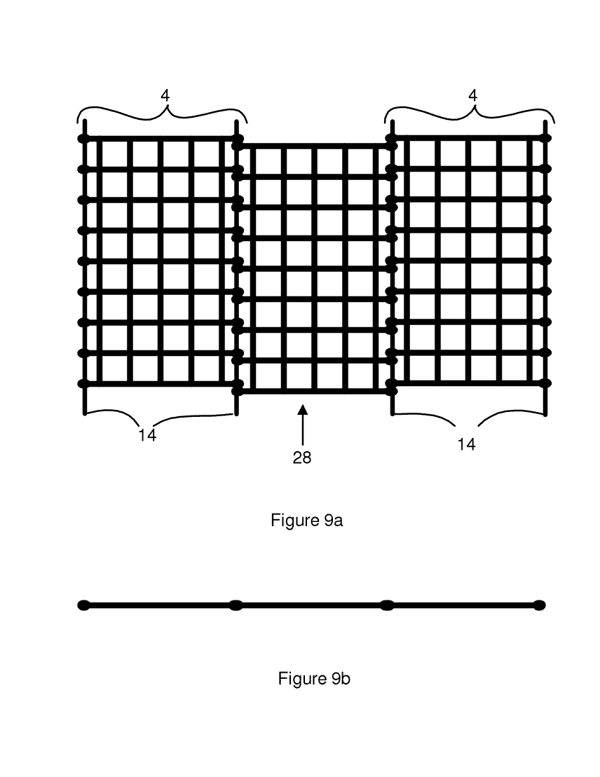

Referencing FIG. 9a, a system 28, in another embodiment, depicts a straight integration of sections 4. Sections 4 do not need to form enclosures. In one embodiment, if sections 4 can be joined using the rod 14 in a straight series, they form a row that supports climbing plants such as beans, snow peas, etc. growing on either side. Referencing FIG. 9b, a top view is shown of FIG. 9a.

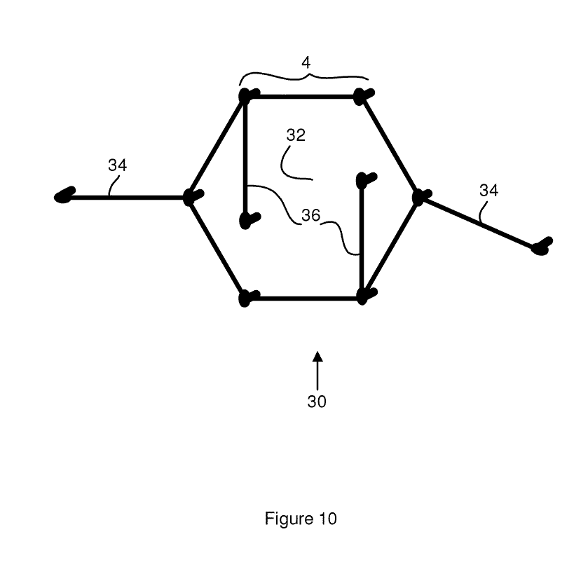

Referencing FIG. 10, system 30, in another embodiment, depicts sections 4 making enclosures as well as open exposed areas. Depending on the number of sections 4 available in one embodiment, sections 4 can be shared, making enclosures as well as open exposed areas. In another embodiment, extensions exists outside of an enclosure 34 (section pointing outward) or inside an enclosed space 36 (section pointed inward).

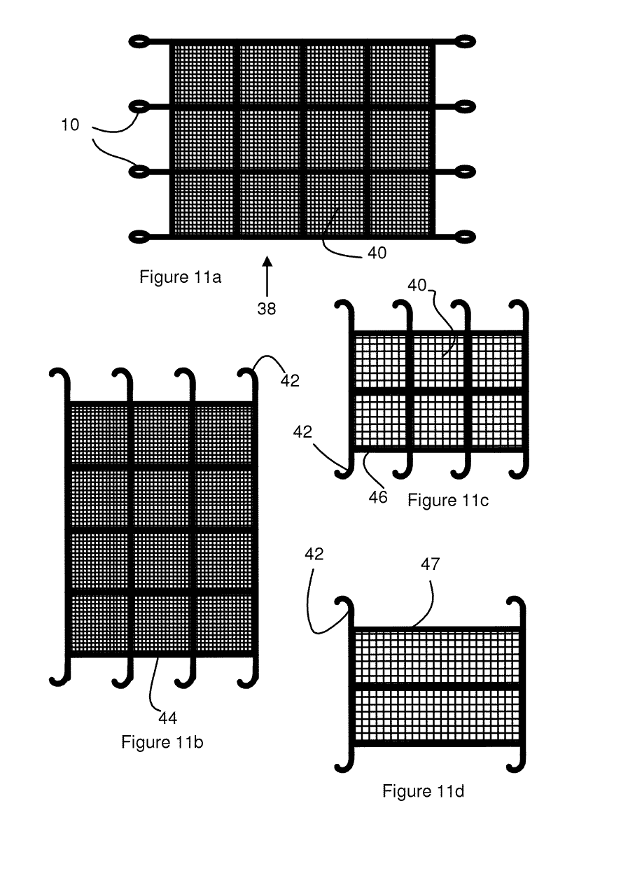

Referencing FIG. 11a, there is shown a mesh section 38 in another embodiment. While the section 4 keeps certain size herbivores and omnivores outside the enclosure, another type of section 38 has a finer/smaller mesh that prohibits access to the inner area while allowing air/sunlight/water to pass through. The size of the mesh opening varies 40. The system of connectivity to a section 4 varies. One embodiment contains loops 10. Referencing FIG. 11b, a section 44 in another embodiment uses hooks 42. Referencing FIG. 11c, in an embodiment, a mesh section 46 can vary in size 40 and use hooks 42. Referencing FIG. 11d, the section 47 can vary in the number of hooks 42 in an embodiment. In other embodiments, one or more of these sections 38 in one or more combinations 40, 42, 44, 46, etc. minimizes the exposure of contained plants to undesirable entrants such as rabbits, deer and other animals that eat plants. The material used in the mesh section does not need to be identical to the material used in the connecting section. In an embodiment, mesh sections or hinge opening sections can be used only with rods 14. In an embodiment, a mesh section is of different heights and does not require consistent spacing within the mesh grid. The mesh grid is created with interconnecting material going in any direction including but not limited to horizontal, vertical, diagonal, and non-grid patterns such as circles or other crooked lines. Mesh sections that incorporate hooks do not need to be the same width as the section the mesh section connects with. In another embodiment, one or more types of mesh sections can be used at the same time on the same section.

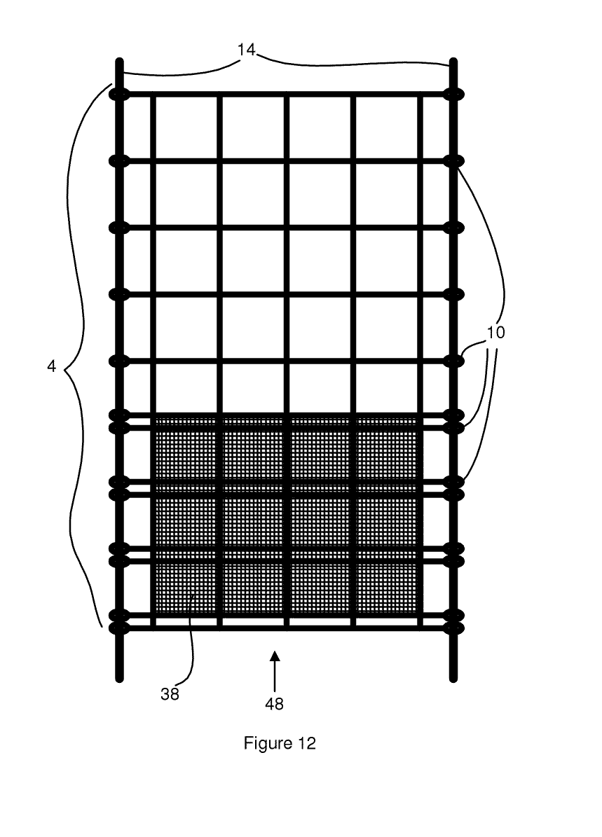

Referencing FIG. 12, a system 48, in another embodiment, combines a section 38 whose loops 10 correspond with a section 4's loops 10 such that the rod 14 will join both sections 4, 38 at the loops 10. This type of combination, in one embodiment, is removed by raising a shared rod 14 without disconnecting/disassembling other sections 4.

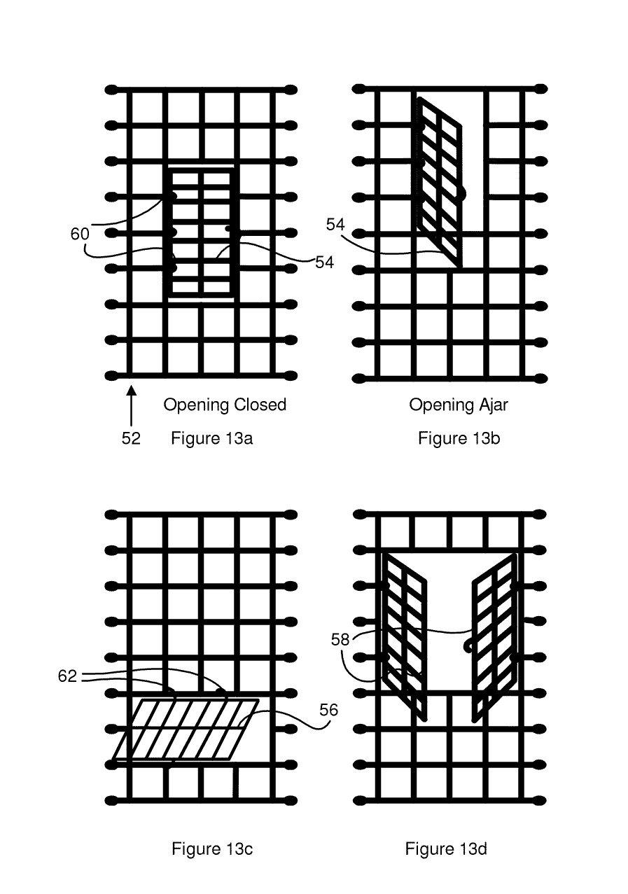

Referencing FIG. 13a, a section 52, in another embodiment, can have a hinge opening. This section 52 allows for the removal or addition of material without removing a whole section. In one embodiment, while a whole section 4 is removed at a connection/support point, there can be situations when access through a smaller portion is desired. A hinge opening 54 can be placed in the middle portion of a section 52. Referencing FIG. 13b, in an embodiment, a section 52 can have a hinge opening 54 at the top portion. Referencing FIG. 13c, in an embodiment, can have a section 52 with a hinge opening 56 at the bottom portion. Referencing FIG. 13d, in an embodiment, multiple hinge openings 58 can be used. Sections 52 do not impact the existing enclosure's stability and rigidity. In other embodiment, combinations of one or more access points 54, 56, 58 of a section 52 can occur. In this configuration, composting of plants occurs by placing new plant or other organic material in from the top portion 54, 58 and removing the desired composted material from the bottom 56. In one embodiment, this type of section 52 can be used when fruits or vegetables are too large to fit through an opening. This hinged opening connection 60, 62 is utilized by this particular type of section 52 and does not require the opening 54, 56, 58 of the section 52 to use the rod 14 hinge component used to join sections. In another embodiment, the hinge is an enclosed loop 60, hook 62 or another mechanism. The material, size, spacing or configuration of an opening does not need to be the same as the other parts of the section 52. In other embodiments, the hinge can allow the hinge openings 54, 56, 58 to move in different directions (left, right, top, bottom, vertical) or be removed depending on the connection mechanism employed. Although a certain configuration of latches is shown, any combination is possible. In one embodiment, one latch is placed on top, in another embodiment two latches can be placed on the bottom. In one embodiment, latches can be detachable.

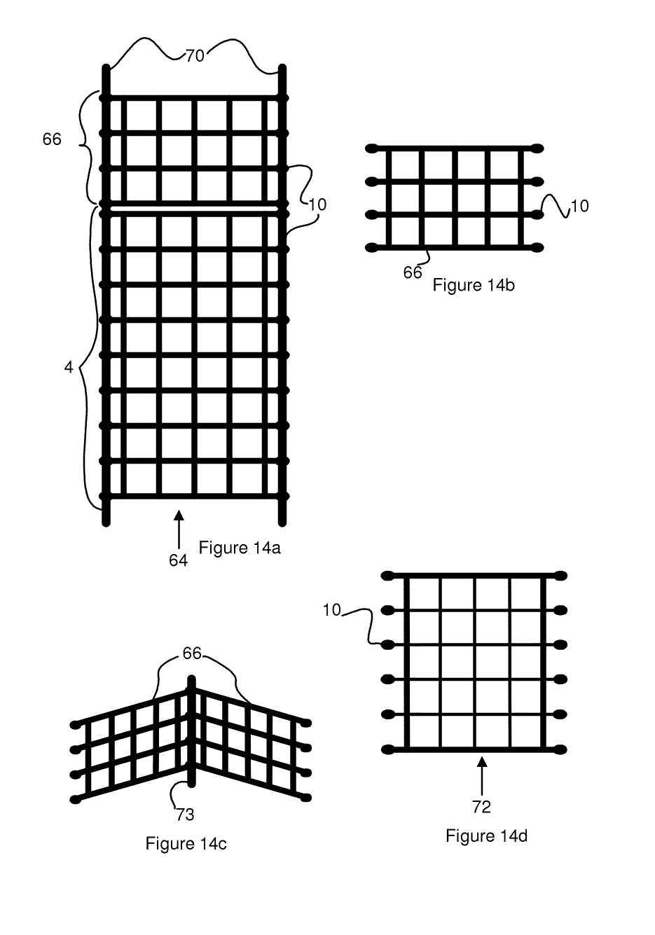

Referencing FIG. 14a, a system 64, in another embodiment, depicts expanding/extending a section. While a section 4 addresses many functional needs, situations occur (for example plants grow taller than a section 4) where an extension 68 can provide additional space and support. Referencing 14b, a section 66, in one embodiment, of any size in inches, feet or other unit of measure, for example, six (6) inches, ten (10) centimeters, one (1) foot, three (3) feet, one (1) meter, etc., is disclosed and used as an extension to section 4. In one embodiment, a section 66 is the same width as a section 4 with connectivity and support occurring at existing pivot points/loop 10 supports using an extended rod 70. Referencing FIG. 14c, in another embodiment, joined sections 66 can be used to protect smaller plants (for example seedlings, flowers, leaf vegetables, etc.) and if desired, can be replaced by larger sections 4 or extended. In yet another embodiment, when only sections 66 are used, the length of the rod 73 can be reduced. Referencing FIG. 14d, in an alternate embodiment, sections 72 can be of different heights. In another embodiment, sections 66 can be of different materials and thicknesses 72. Additional embodiments can include various combinations of both.

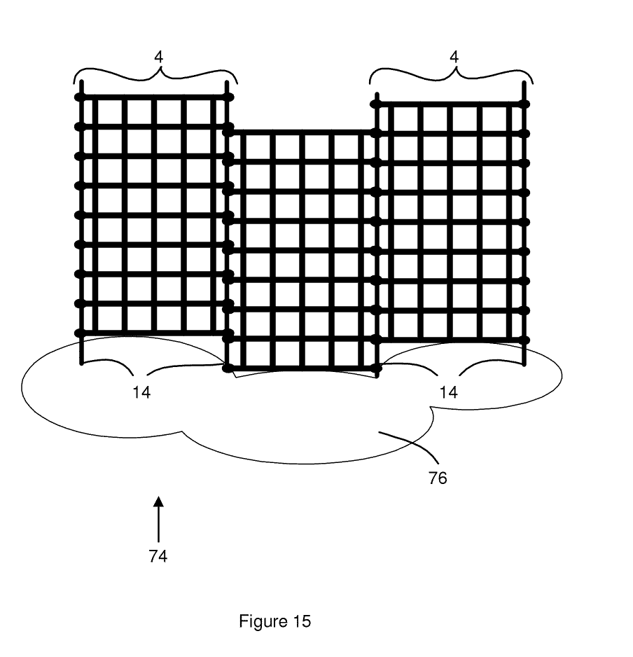

Referencing FIG. 15, a system 74, in another embodiment, depicts sections 4, coupled by a rod 14, at different heights. Allowing sections 4 to be positioned at different heights permits use of sections on uneven surfaces 76.

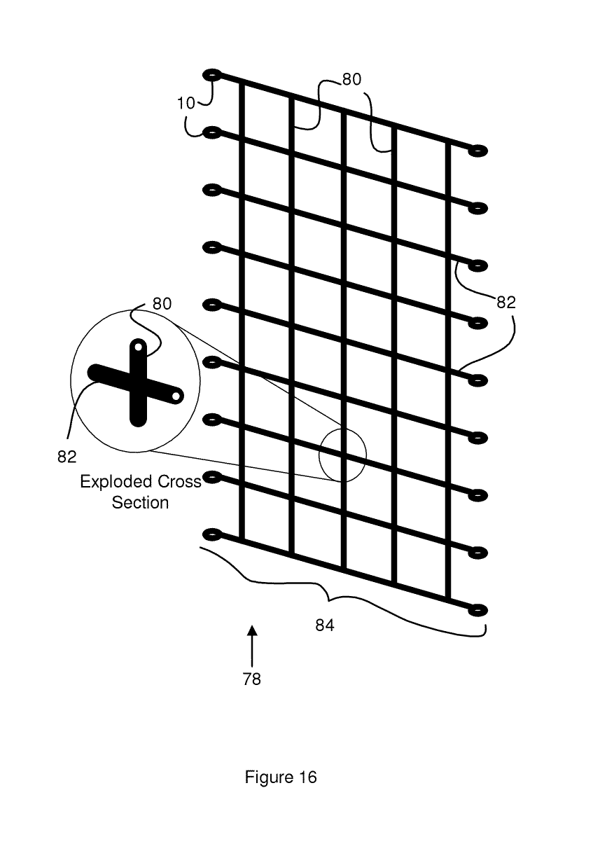

Referencing FIG. 16, a system 78, in another embodiment, depicts at least one vertical element 80 or at least one horizontal element 82 or a combination of both to be hollow. When an element 80, 82 is hollow with an exposed end, detachable attachments can be used in one embodiment. In another embodiment, a hollow element section 84 is coupled with another hollow element section 84 or a section 4 using the rod 72.

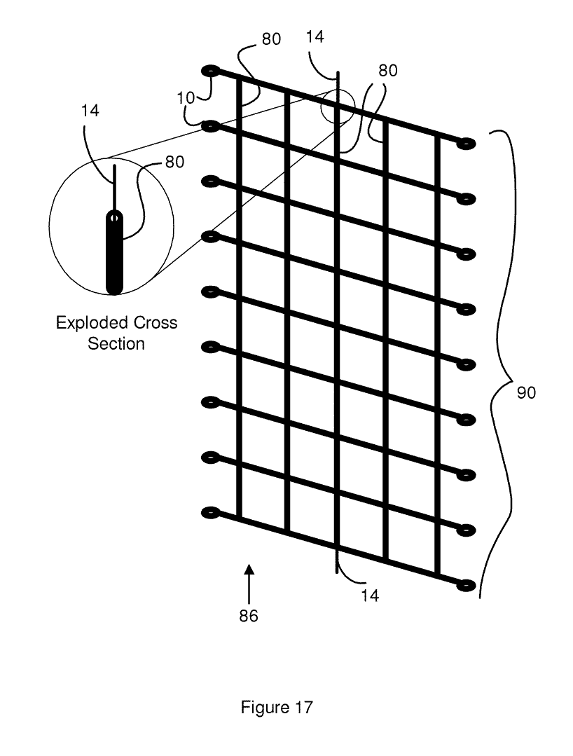

Referencing FIG. 17, a system 86, in another embodiment, depicts a section 90 with at least one hollow vertical element 80 at one or more ends with a rod 14 passed through one or more ends.

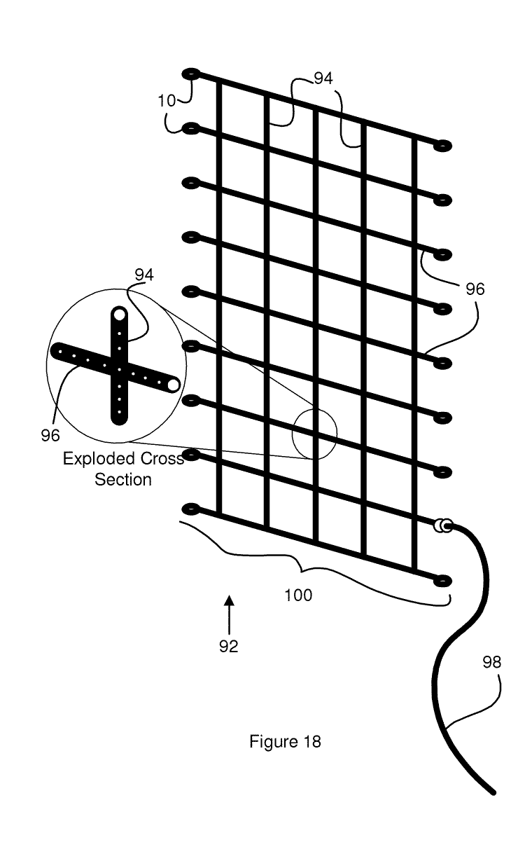

Referencing FIG. 18, a system 92, in another embodiment, depicts at least one vertical element 94 or at least one horizontal element 96 or a combination of both to be hollow and perforated. In alternate embodiments, perforations can be of a uniform shape, a non-uniform shape, a uniform size, a non-uniform size, a uniform distance apart, a non-uniform distance apart, located anywhere on the at least one vertical element 94 or at least one horizontal element 96. When combined with an external connection mechanism 98, a section 100 allows for the distribution of fluids including, but not limited to water, nutrients, etc.

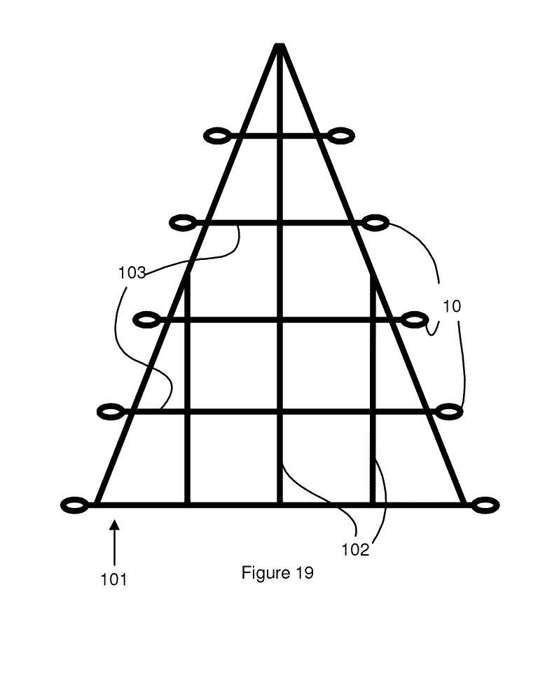

Referencing FIG. 19, a system 101, in another embodiment, depicts vertical elements 102 and horizontal elements 103 of uneven lengths. The ends of the horizontal elements 103 incorporate loops 10 at fixed points. In one embodiment, at least three of the sections 101 can be joined and supported at the designated connection point 10 with rods 14 forming a pyramid or teepee enclosure depending on the number of sections 101 used. In another embodiment only vertical elements 102 are of uneven lengths. In yet another embodiment, only horizontal elements 103 are of uneven length.

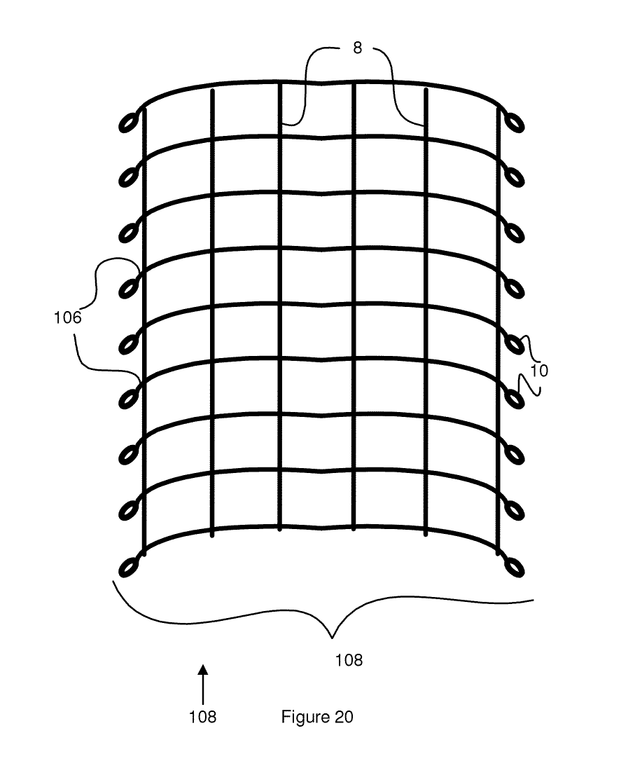

Referencing FIG. 20, a system 108, in another embodiment, depicts horizontal elements 106 that are not straight. In previous figures, a section 4 was depicted with straight horizontal and vertical elements. The ends of the non straight horizontal elements 106 incorporate loops 10 at fixed points. These loops are not independent of the horizontal elements 106. In one embodiment, while sections 108 have variations in function, they also can be the same width to provide for interchangeability and integrated support at a designated location. A section 108 is shown with curved horizontal elements. It should be noted throughout the disclosure that any reference to a section 108 includes the loops 10, but not the rod 14.

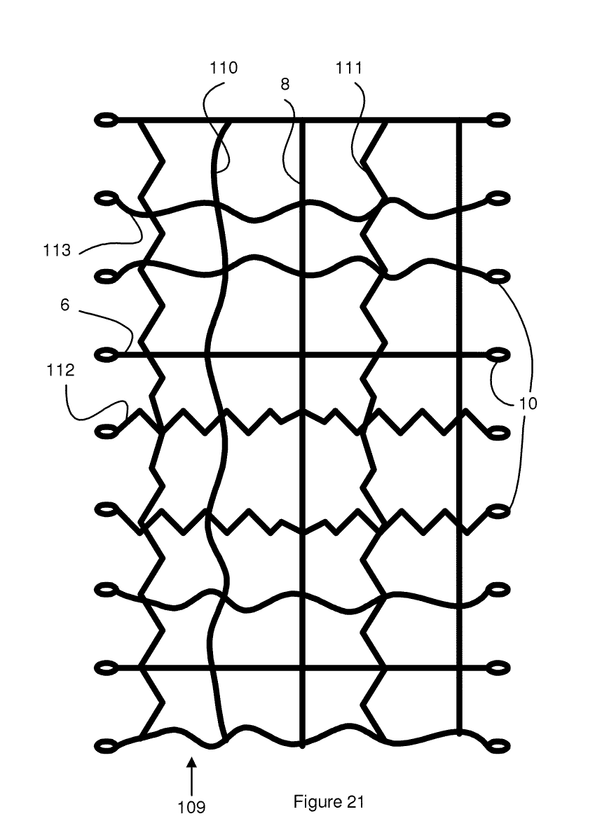

Referencing FIG. 21, a system 109, in another embodiment, depicts at least one or more vertical elements for example 8, 110, 111, and at least one or more horizontal elements for example 6, 112, 113 that can be straight or crooked with incorporated loops 10. Depending on the requirements, in one embodiment, a section 4 employs at least one or more of a straight or crooked vertical element 8, 110, 111 and at least one or more of a straight or crooked horizontal element 6, 112, 113 to address a particular need. In another embodiment, sections 4 are not restricted to geometric shapes with straight sides such as rectangles, squares, triangles, etc. but also geometric shapes with crooked sides such as ovals, circles, hourglass, etc.

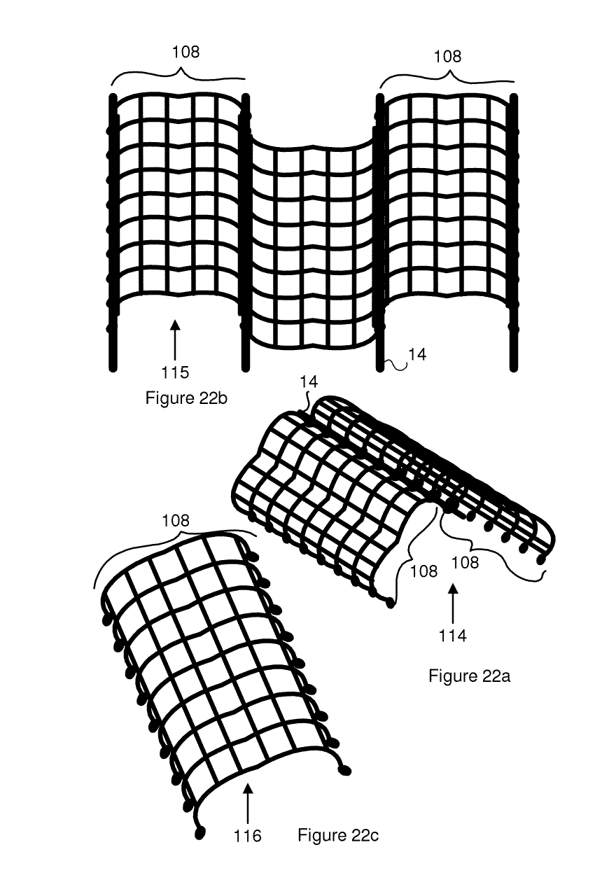

Referencing FIG. 22a, a system 114, in another embodiment, connects two or more sections 108 using the rod 14. In another embodiment, curved sections 108 can be joined facing the same direction 114. Referencing FIG. 22b, in another embodiment, the curved sections can be joined in an opposite direction 115. Referencing FIG. 22c, besides being used in a vertical position, sections can be used in a horizontal position 116 in an alternate embodiment. In one embodiment, a section 108 when positioned horizontally 114, 116 is laid over small plants (for example seedlings, flowers, leaf vegetables, etc.) or other objects. If additional horizontal coverage 114 is desired sections 108 using the rod 14 can be joined in yet another embodiment. Protection from living creatures such as herbivores, omnivores, and air-borne intruders such as birds and insects can occur in an embodiment using sections 108 in a horizontal position.

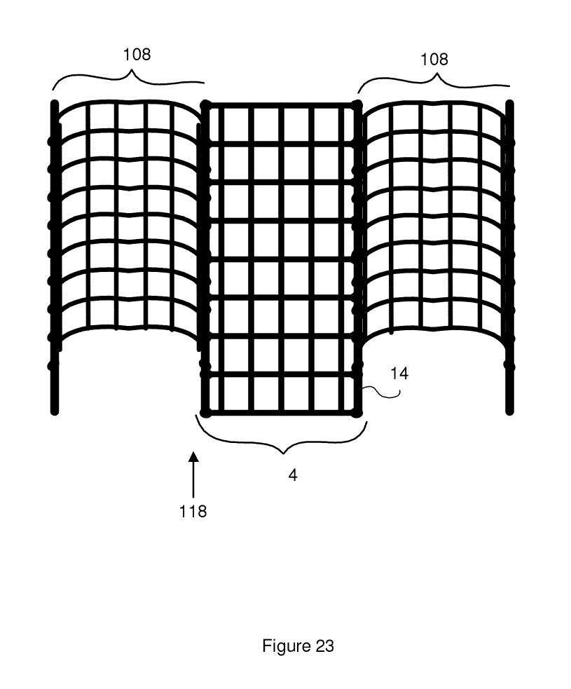

Referencing FIG. 23, a system 118, in another embodiment, includes section 108 and section 4 which can be coupled using the rod 14. In another embodiment, a curved section 108 is combined or joined with sections (for example section 4, 16, 18, 22, 24, 28, 30, 48 or 52) in numerous combinations.

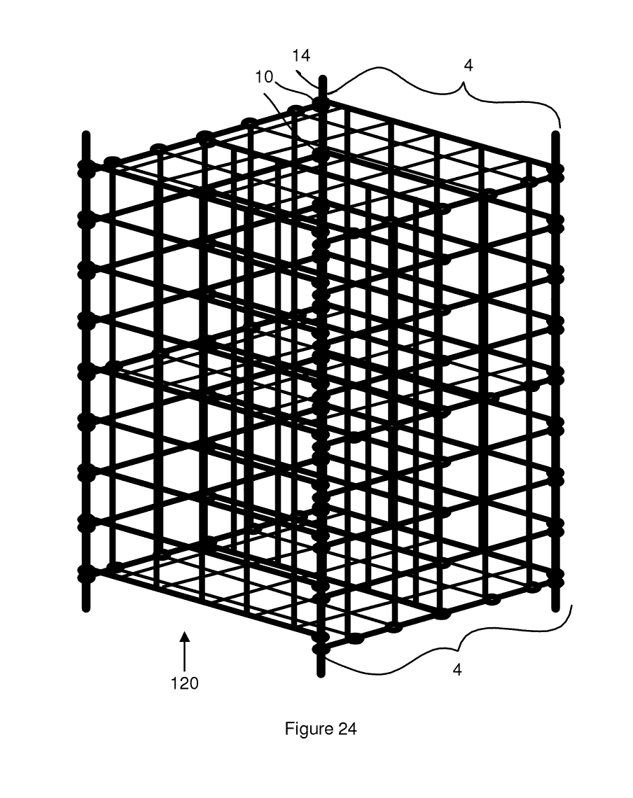

Referencing FIG. 24, a system 120, in other embodiment, includes sections 4, a roof, a floor, a shelf, an interior wall, and an exterior wall. In other embodiments, section 108 or other section types provide similar functionality. When combined with appropriate material in another embodiment, a section 4, 108 or other section types provide protection from air-borne intruders, cold weather/frost or reduce exposure to wind or sun.

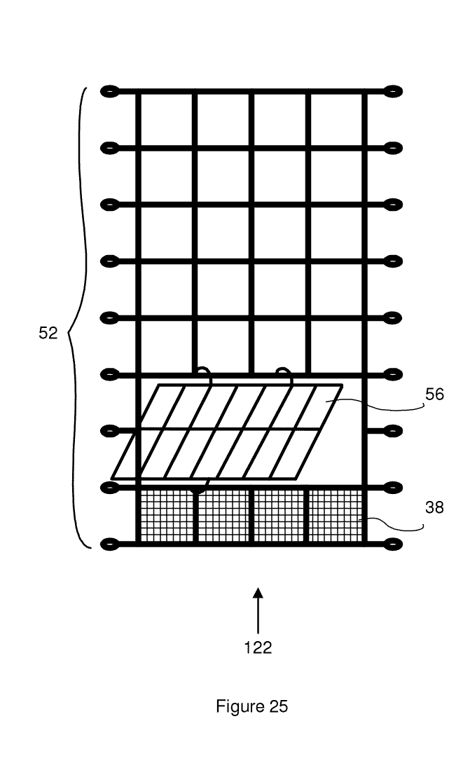

Referencing FIG. 25, a system 122, in another embodiment, combines features from other sections. For example, an integration of the mesh section 38 with the section 52 that has a hinged or hooked bottom 56 reduces the chance of rodents or other undesirable creatures from nesting in a compost pile or accessing a plant. Another embodiment can use a curved section as a top to the enclosure. In other embodiments, any descriptions or depictions herein can be combined.

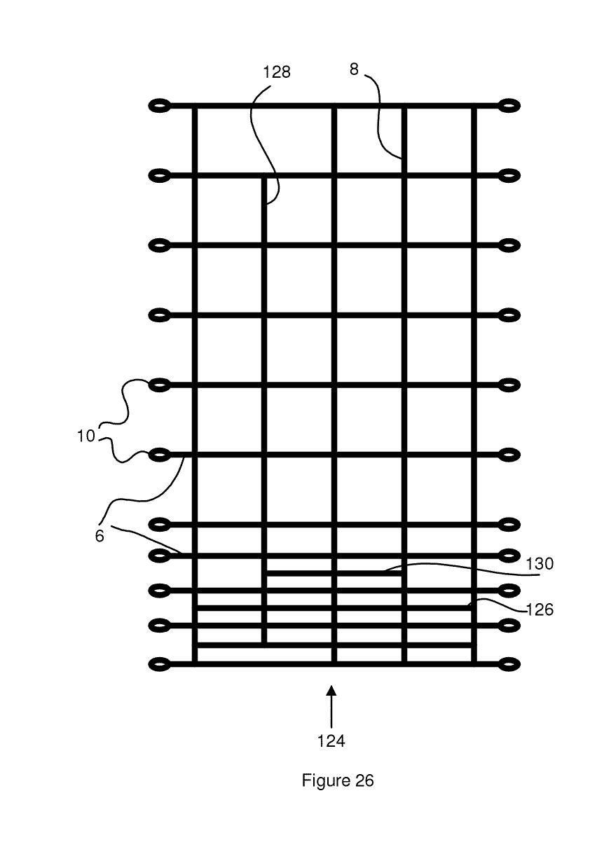

Referencing FIG. 26, there is shown a section 124, in another embodiment, depicting variable spacing of horizontal components. In situations where horizontal or vertical components can be evenly spaced apart, they are said to be uniform. Non-uniform is defined herein as not evenly spaced apart or a combination of evenly and uneven horizontal and vertical components. In one embodiment, horizontal components 126 may not have support loops 10 and may not span all vertical components 130. In one embodiment, vertical components 128 may not span all horizontal components 6.

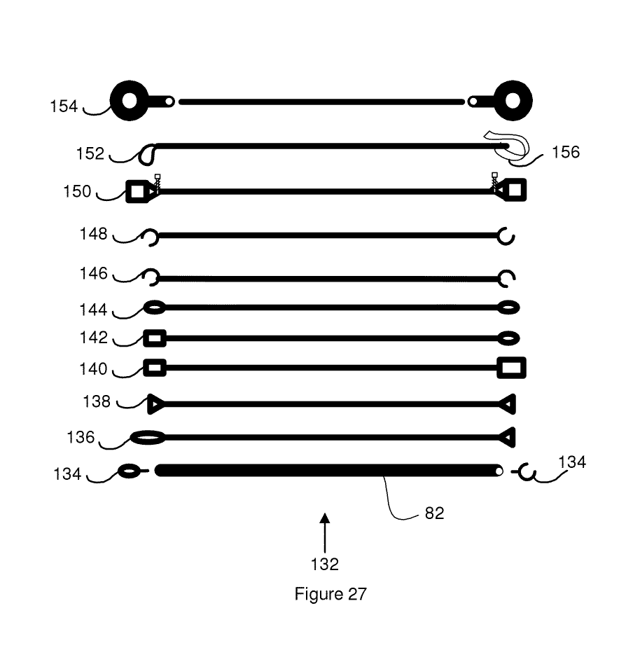

Referencing FIG. 27, there are shown various loops 132 in different configurations. In one embodiment, attachable and detachable loops 134 can be attached into horizontal elements or detached from horizontal elements. In another embodiment, loops can be of uniform 138 or non-uniform sizes 140, 142, of similar material or dissimilar material 152, 156, of uniform 138 or non-uniform shapes 136, for example circle 144, square 140, triangle 138, or octagon. Loops do not need to be the same on each side of a horizontal component 136, 140, 144, 152. In another embodiment, loop ends can be detachable 134, 154. In yet another embodiment, loops can rotate 148 to allow a top attachment or insertion 154 of horizontal sections in the center. In other embodiments, loops can be made of Velcro® 156, a clamp 150 or other material that allows for the acceptance 154 of a rod. In another embodiment, loops can be continuous 136, 138, 140, 144 or non-continuous 146, 148.

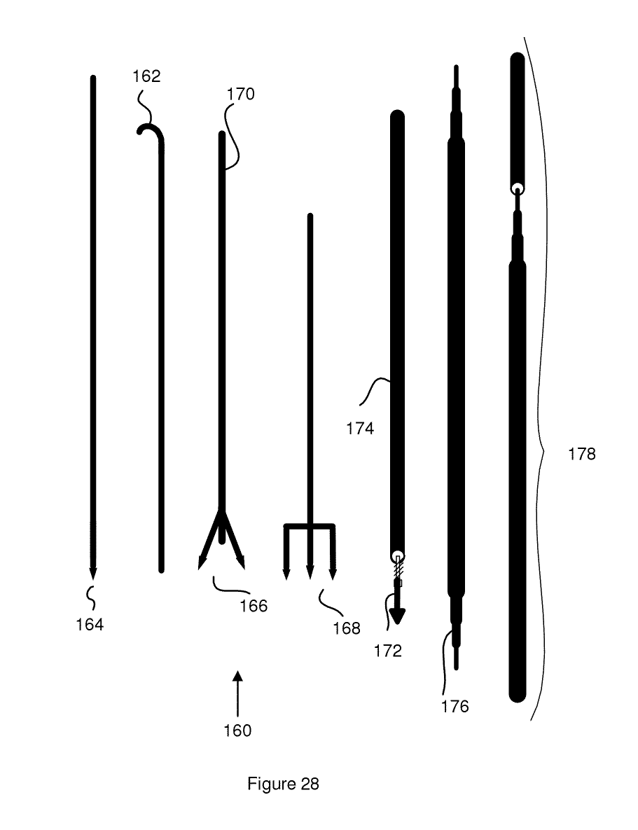

Referencing FIG. 28, there are shown various rods 160, in different configurations. In one embodiment, the end of a rod has a hook 162 to prevent the rod from being pushed too far when inserted through support loops. In alternate embodiments, the rod has different ends 164, 166, 168 to aid in the pushing of the rod into a substance, ground or surface and for improved stability. In yet another embodiment, the number of end points varies from one 164, two 166, three 168 or more. Another embodiment has a thicker rod 170, 174, 176. In another embodiment, the rod varies in height 164, 168, 170. In yet other embodiments, a combination of one or more rod alternatives is applied. In another embodiment, rod ends 172 can be detachable. The length of the rod in one embodiment is extendable by using a telescoping/expanding rod 176 incorporated at one or more ends. In one embodiment, the rod is fixed and one or more ends can be extended using the telescoping/expanding rod 176. In another embodiment, the rod is hollow 174. This allows for multiple rods to be joined by inserting one end of a rod into another rod 178.

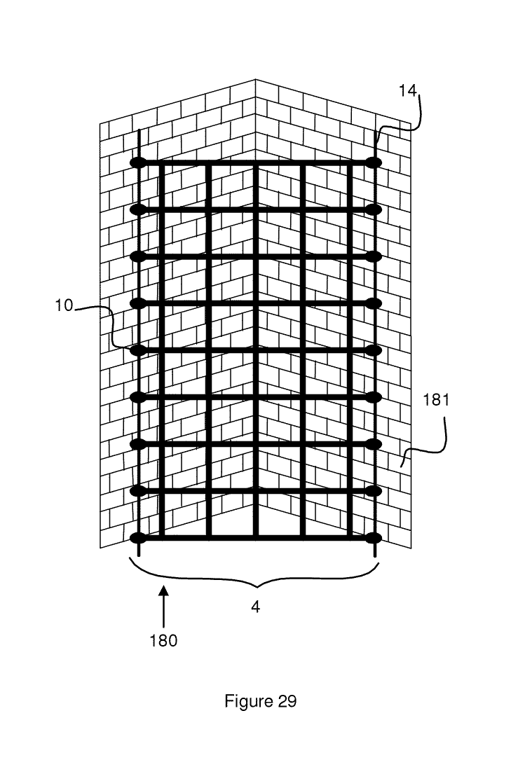

Referencing FIG. 29, a system 180, in another embodiment, makes an enclosure with only one section 4 and one or more rods inserted through one or more of the integrated loops and another structure 181, such as a wall, a fence, a rock, a bush, a shrub, etc. In still another embodiment, sections combine with non-sections. In this embodiment, an inside corner of a structure is closed off when one or more sections can be applied or when existing elements of a separate structure can be incorporated with any combination of sections, resulting in a hybrid system.

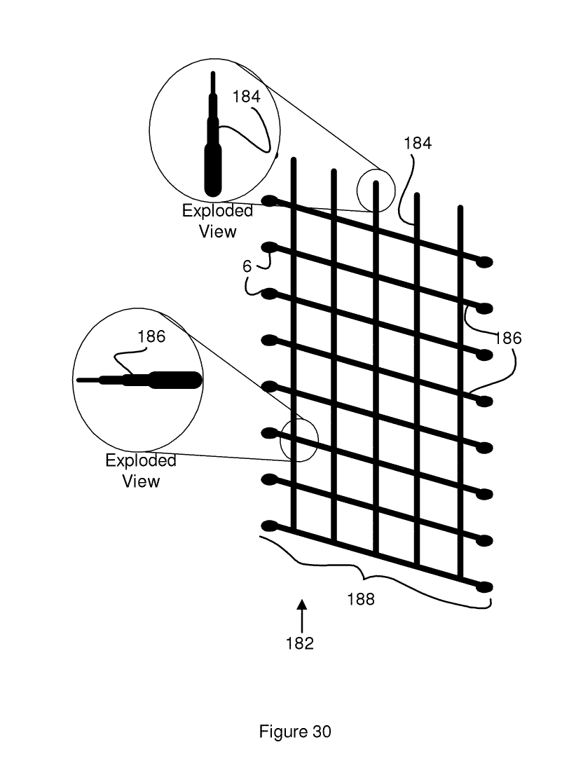

In FIGS. 30 through 33, in other embodiments, a telescoping element is depicted. The telescoping mechanism can be extended to various lengths and locked into position. In an embodiment, the locking mechanism can use a twist/screw method to maintain the extension. In another embodiment, a series of holes can exist when combined with a pin, prevent the extension from compressing until it is removed. Alternate embodiments can use other locking mechanisms or combinations of the locking mechanisms described.

Referencing FIG. 30, a system 182, in another embodiment, depicts at least one vertical element 184 with at least one telescoping/expanding end. In another embodiment, at least one horizontal element 186 has at least one telescoping/expanding end. A section 188 has at least of: at least one telescoping/expanding vertical element 184 end, at least one telescoping/expanding horizontal element 186 end. In one embodiment, a section 188 has at least of: at least one perforated vertical element 184 with a telescoping/expanding end, at least one perforated horizontal element 186 with a telescoping/expanding end.

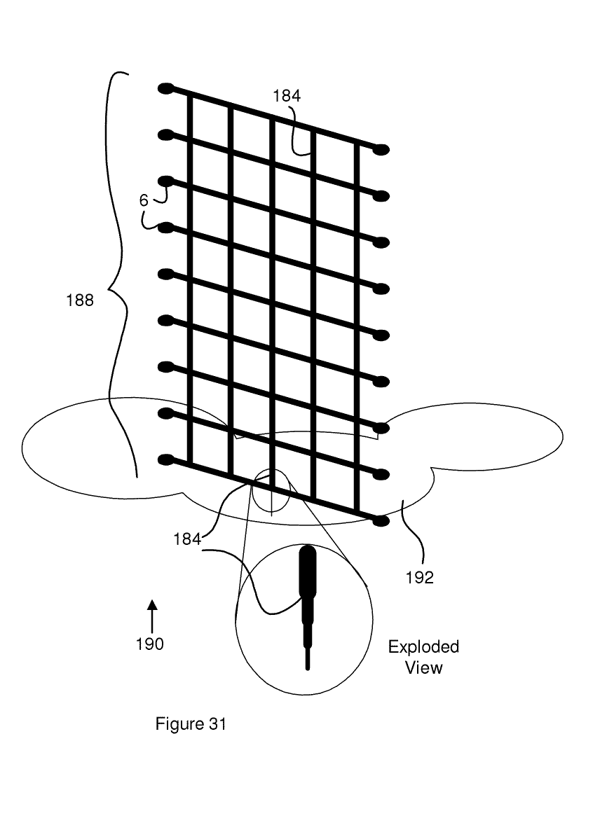

Referencing FIG. 31, a system 190, in another embodiment, depicts at least one vertical element 184 with at least one telescoping/expanding end inserted into a surface 192.

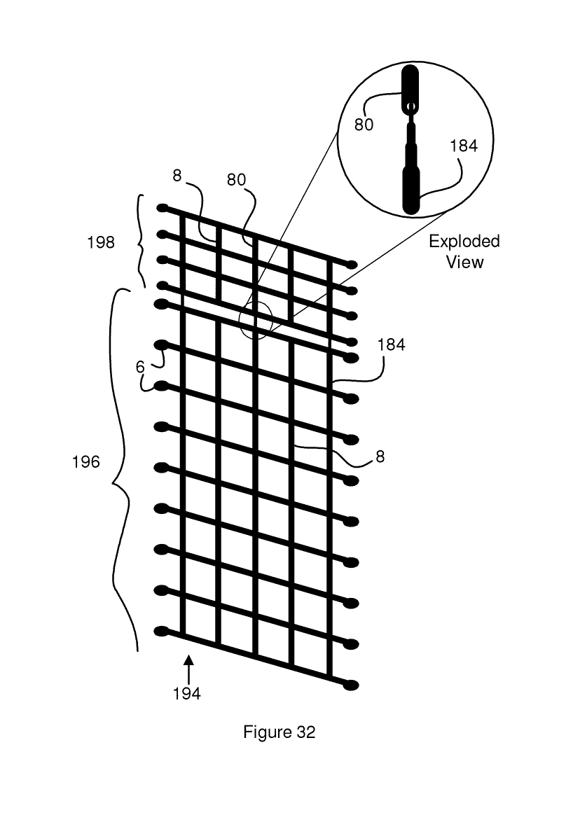

Referencing FIG. 32, a system 194, in another embodiment, depicts a section 196 with at least one telescoping/expanding vertical element 184 at at least one end coupled with a section 198 with at least one hollow vertical element 80 at at least one end.

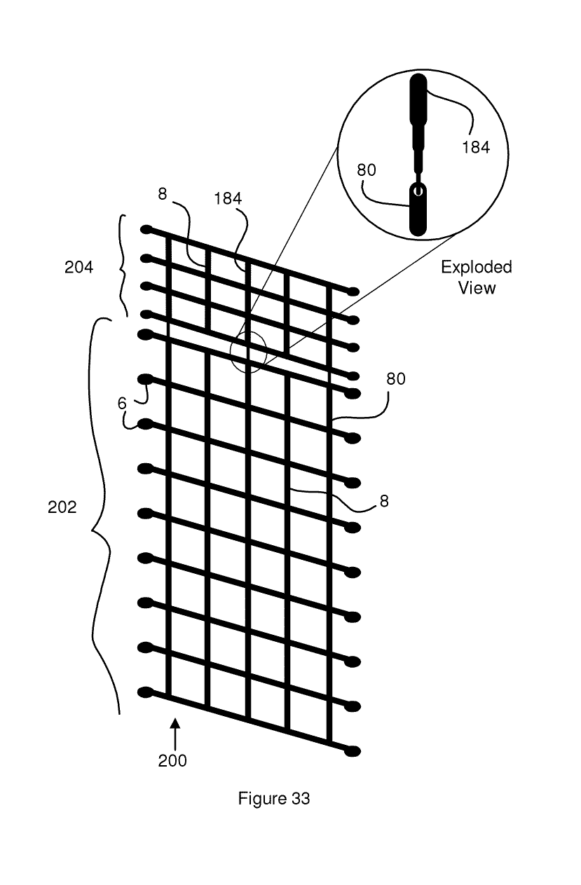

Referencing FIG. 33, a system 200, in another embodiment, depicts a section 202 with at least one hollow vertical element at at least one end coupled with a section 204 with at least one telescoping/expanding element at at least one end.

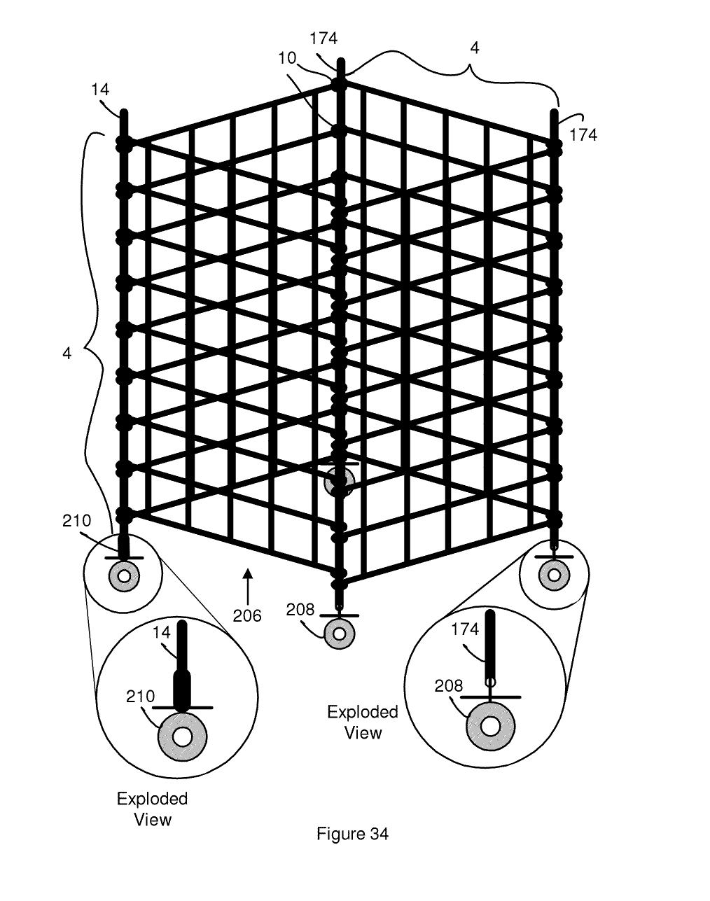

In FIGS. 34 through 36, in other embodiments, a caster, wheel or any electronic or non-electronic object capable of facilitating movement is depicted. In an embodiment, the weight of the sections is sufficient to hold the caster in place. In other embodiments, the object capable of facilitating movement is attached through a screw on mechanism, a pin, an alternative means, or a combination of one or more mechanisms.

Referencing FIG. 34, a system 206, in another embodiment, depicts at least one of: a rod 174 which accepts a caster 208, wheel or any electronic or non-electronic object capable of facilitating movement, the rod 14 is inserted into a caster 210, wheel or any electronic or non-electronic object capable of facilitating movement.

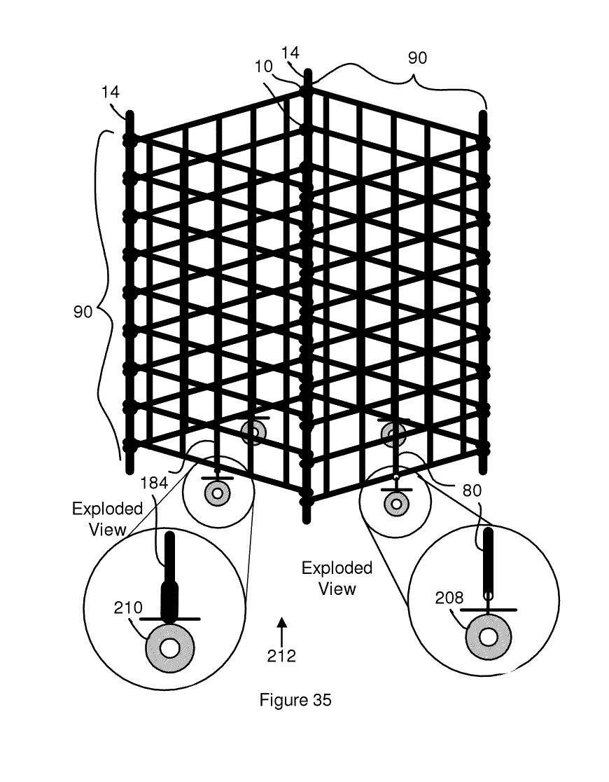

Referencing FIG. 35, a system 212, in another embodiment, depicts an at least one of: an enclosure of at least one section 84 with at least one hollow vertical element 80 that accepts a caster 208, wheel or any electronic or non-electronic object capable of facilitating movement, an enclosure of at least one section 188 with at least one telescoping vertical element 184 that receives a caster 210, wheel or any electronic or non-electronic object capable of facilitating movement.

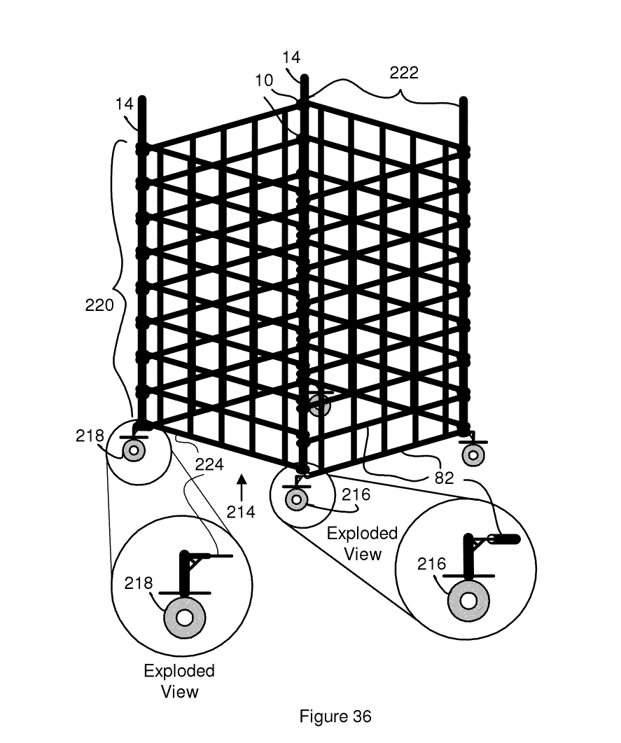

Referencing FIG. 36, a system 214, in another embodiment, depicts an enclosure of at least one of: at least one section 220 with at least one hollow horizontal element 82 that accepts a pivotable caster 216, wheel or any electronic or non-electronic object capable of facilitating movement, at least one section 222 with at least one horizontal element 224 that inserts into a pivotable caster 218, wheel or any electronic or non-electronic object capable of facilitating movement. In another embodiment, casters 218, wheels or any electronic or non-electronic object capable of facilitating movement can be added to the horizontal elements in place of a loop. In alternate embodiments, the addition of casters 216, wheels or any electronic or non-electronic object can be accomplished through previously discussed systems of replacing an existing removable end with the object, sliding the object over an existing end or attaching the object via clamps, straps, bolts or other mechanism at any vertical or horizontal element or rod. In other embodiments, where the object is not in-line with the surface to facilitate movement, the angle of attachment of the object is adjustable.

In another embodiment, casters 216, wheels or any electronic or non-electronic object can be incorporated through a combination of previously discussed systems for example, at least one of; a rod 14 and caster 210, a rod 174 and caster 208, a vertical element 184 and caster 210, a vertical element 80 and caster 208, a horizontal element 82 and caster 216, a horizontal element 224 and caster 218. In one embodiment, casters 216, wheels or any electronic or non-electronic object may be incorporated only on one side of the enclosure. Lifting the other side of the enclosure, and utilizing the casters 216, wheels or any electronic or non-electronic object, facilitates movement.

While applicable to interacting with organic material, alternate embodiments of structural and non-structural configurations can be used for pets, objects and other material where it is desired to restrict movement or provide storage, without departing from the scope of the disclosure.

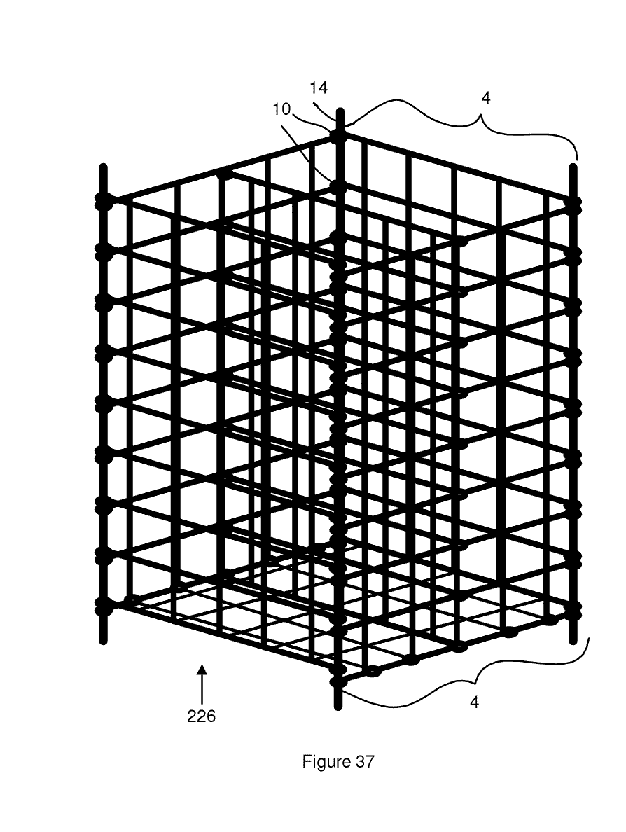

For example, referencing FIG. 37, a system 226, in another embodiment, depicts an enclosure of sections 4 with sections coupled vertically as well as at least one horizontally. Vertical sections 4 form external surfaces as well as at least one interior surface. The horizontal section 4 forms a bottom surface. This enclosure provides storage of different items. Alternate embodiments incorporate at least one of: more horizontal sections providing a roof/top as well as multiple floor layers and more vertical sections providing dividers/walls.

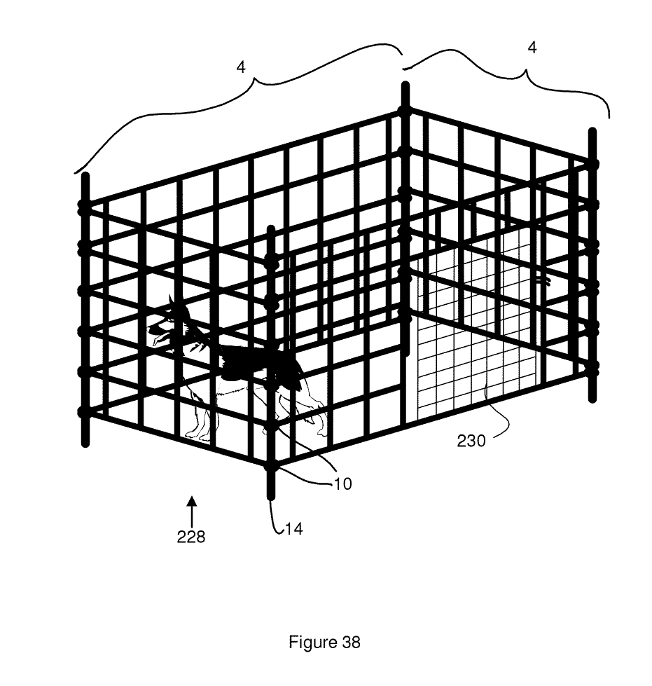

For example, referencing FIG. 38, a system 228, in another embodiment, depicts an enclosure of coupled sections with a section that incorporates a subsection 230. This enclosure provides restricted movement to objects within the enclosure. This enclosure also provides restricted access by objects within the enclosure to objects outside the enclosure. In previous embodiments, enclosures can restrict access to items within an enclosure.

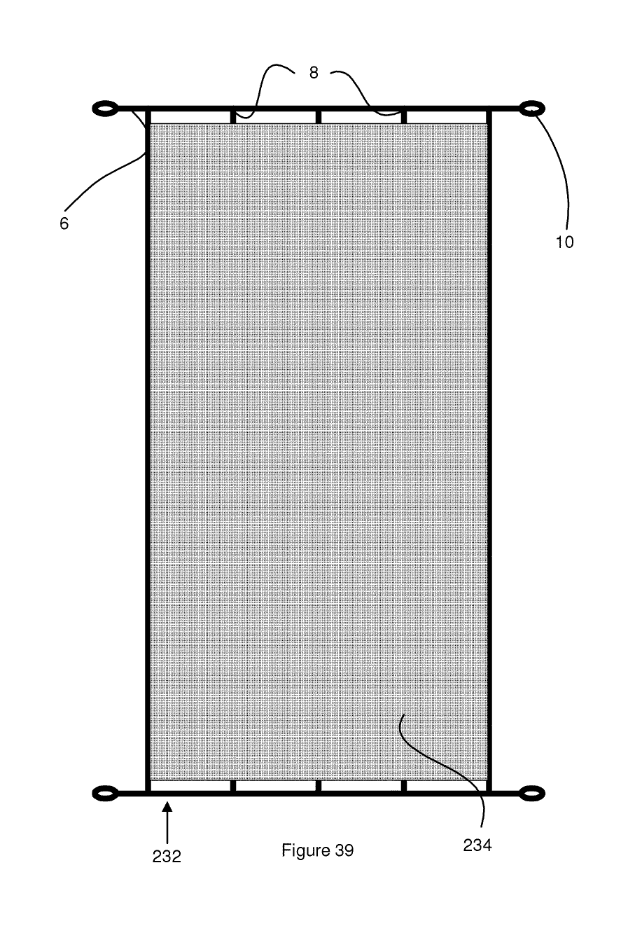

Referencing FIG. 39, a system 232, in another embodiment depicts a combination of horizontal elements 6, vertical elements 8, loops 10 with a material 234. In one embodiment, this material may be solid, porous or both and be constructed with at least one of: metal, wood, plastic, cloth, and other materials and substances. In another embodiment, the material may be a non-solid material of at least one of: a woven cloth, woven plastic, pieces of material abutting one another. In another embodiment, the material 234 can be a combination of at least one of a solid material and at least one of a non-solid material. The material 234, in one embodiment, may cover a portion of the section or may cover the entire section. In another embodiment, the material can be a solar panel providing alternative functionality. Attachment of a system 232 to other sections (for example section 4, 16, 18, 22, 24, 28, 30, 48 or 52) in numerous combinations can occur through at least one of the rod 160 options and at least one of the loop 132 options.

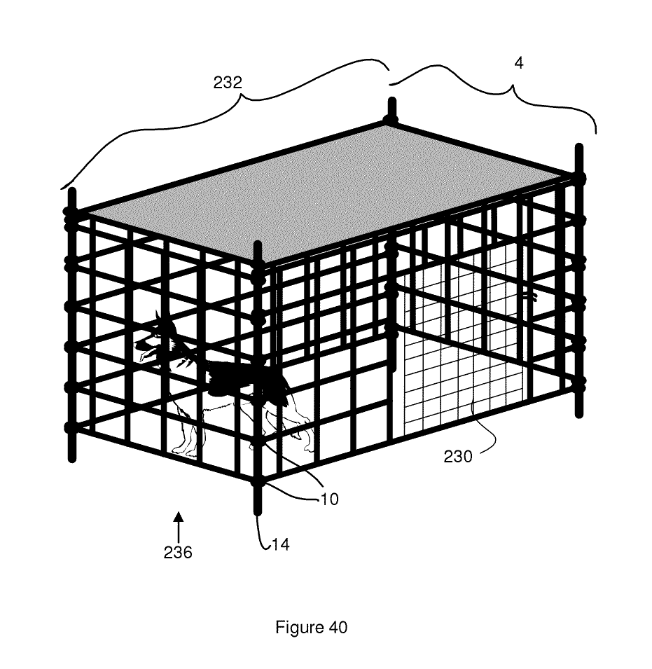

Referencing FIG. 40, a system 236, in another embodiment, depicts an enclosure of coupled sections 4 with a section that incorporates a subsection 230 and a section 232. The section 232, in one embodiment, can provide objects within the enclosure protection from the elements such as wind, cold, rain, sun, any other object. In another embodiment, section 232 may restrict movement of at least one internal object. In another embodiment, when section 232 is made from a material that can support weight, enclosures can be stacked on top of each other.

Although embodiments of the present invention have been illustrated in the accompanied drawings and described in the foregoing description, it is understood that the invention is not limited to the embodiments disclosed, but is capable of numerous rearrangements, modifications, and substitutions without departing from the spirit of the invention as set forth and defined by the following claims.

What is claimed is:

1. A system, comprising:
a first section, comprising:
a plurality of horizontal elements, wherein each of the elements consists of an integrated loop at either end of the elements, wherein the elements are evenly spaced apart; and
a second section, comprising:
a plurality of horizontal elements, wherein each of the elements consists of an integrated loop at either end of the elements, wherein the elements are evenly spaced apart.

2. The system of claim 1 comprising:
at least one vertical element coupled to the horizontal elements of the first section; and
at least one vertical element coupled to the horizontal elements of the second section.

3. The system of claim 1, comprising a rod configured to join the first section and the second section when positioned through the integrated loop at one end of each of the plurality of horizontal elements of the first section and through the integrated loop at one end of each of the plurality of horizontal elements of the second section, wherein the rod, while still configured to join the first section and the second section allows the sections to pivot at at least one angle.

4. The system of claim 1, wherein the rod, while still configured to join the first section and the second section has sufficient length to be inserted into a substance.

5. The system of claim 1, wherein the rod, while still configured to join the first section and the second section has sufficient length to integrate at least one further section.

6. The system of claim 5, wherein the at least one further section is integrated vertically with at least one of:
the first section; and
the second section.

7. The system of claim 1, wherein the rod is at least one of:
a uniform length;
a non-uniform length;
a uniform thickness;
a non-uniform thickness;
extendable;
includes a detachable end;
is hooked at at least one end of the rod;
is hollow at at least one end;
is pointed on at least one end of the rod;
is forked at at least one end of the rod; and
is perforated at at least some portion of its length.

8. A system, comprising:
at least one horizontal element that consists of an integrated loop at either end of the at least one element; and
at least one vertical element coupled to the at least one horizontal element.

9. The system of claim 8, wherein a space between the at least one horizontal element and a space between the at least one vertical element is at least one of:
a uniform distance; and
a non-uniform distance.

10. The system of claim 8, wherein the at least one horizontal element is configured to connect with one or more subsections that consists of at least one subsection horizontal element and at least one subsection vertical element.

11. The system of claim 10, wherein the one or more subsections are configured to move or be removed independent of the at least one horizontal element or the at least one vertical element.

12. The system of claim 10, comprising an opening between the at least one horizontal element and the at least one vertical element, wherein the one or more subsections are configured to move or be removed in proximity to the opening.

13. The system of claim 8, wherein the at least one of the horizontal element and the at least one vertical element are at least one of:
straight;
crooked;
a uniform length; and
a non-uniform length.

14. The system of claim 8, wherein the integrated loop at either end of the at least one horizontal element is at least one of:
a circle;
a square;
a triangle;
an octagon;
a uniform shape;
a non-uniform shape;
a uniform size;
a non-uniform size;
similar material;
dissimilar material;
solid;
hollow;
continuous; and
non-continuous.

15. The system of claim 8, wherein the integrated loop at either end of the at least one horizontal element is at least one of:
fixed;
detachably attached; and
telescoping.

16. A system, comprising:
at least one horizontal element that is at least one of:
straight and crooked, wherein the at least one horizontal element consists of an integrated loop at either end of the at least one element; and
at least one vertical element that is at least one of:
straight and crooked, wherein the at least one vertical element is coupled to the at least one horizontal element.

17. The system of claim 16, wherein the elements are coupled to form at least one of:
at least one section that extend in at least one direction;
at least one section that forms at least one enclosure;
at least one section that extends in at least one direction and that couples with at least one enclosure;
at least one enclosure;
an enclosure that couples with at least one similar enclosure; and
an enclosure that couples with at least one dissimilar enclosure.

18. The system of claim 17, wherein at least one of: at least one of the sections and at least one of the enclosures form at least one of:
a roof;
a floor;
a shelf; and
a wall.

19. The system of claim 17, wherein at least one of the enclosures forms at least one of:
a square;
a rectangle;
a triangle;
a geometric shape with straight sides;
a geometric shape with crooked sides;
a simple polygon;
a complex polygon;
a regular polygon;
a irregular polygon; and
a geometric shape within another geometric shape.

20. The system of claim 16, wherein at least one of: the at least one horizontal element, the at least one vertical element and a rod configured to join two or more of the systems, is configured to couple an object capable of facilitating movement.
